(19) United States
(12) Patent Application Publication
(10) Pub. No.: US 2019/0037484 A1
(43) Pub. Date: Jan. 31, 2019

(54) Mobile Device Roaming

(71) Applicant: Evolved Intelligence Limited, Bradley Stoke (GB)

(72) Inventors: Kevin Davies, Bradley Stoke (GB); Mark Greening, Bradley Stoke (GB); Nick Jones, Bradley Stoke (GB)

(73) Assignee: Evolved Intelligence Limited, Bradley Stoke (GB)

(21) Appl. No.: 16/048,033

(22) PCT Filed: Sep. 7, 2017
(86) PCT No.: PCT/GB2017/052612

§ 371 Date: Jul. 27, 2018

Related U.S. Application Data
(63) Continuation of application No. 15/289,423, filed on Oct. 10, 2016.

(30) Foreign Application Priority Data
Sep. 7, 2016 (GB) 1615198.7

(51) Int. Cl. H04W 48/18; H04W 36/32; H04W 64/00; H04W 8/12; H04W 8/02; H04W 8/04; H04W 48/14; H04W 48/04

(52) U.S. Cl. CPC H04W 48/18; H04W 36/32; H04W 64/00; H04W 8/12; H04W 48/04; H04W 8/04; H04W 48/14; H04W 8/02

(57) ABSTRACT

There is provided a method of initiating a search for a home network in a mobile device that is attached to a network other than a home network of the mobile device, the method in an apparatus comprising determining whether the mobile device is in a part of said other network where there may be coverage from the home network; and if the mobile device is determined to be in a part of said other network where there may be coverage from the home network, sending a message to said other network in order to change one or more of a voice, messaging and/or data service available to the mobile device, such that the mobile device can enter an idle state and perform a search for the home network.

### CROSS REFERENCE

This application is a continuation-in-part of U.S. patent application Ser. No. 15/289,423, filed on Oct. 10, 2016 which claims priority to Great Britain Patent Application No. 1615198.7, filed on Sep. 7, 2016, and PCT Patent Application No. PCT/GB2017/052612, filed on Sep. 7, 2017, all of which are hereby incorporated as if set forth in full in this application for all purposes.

### TECHNICAL FIELD OF THE INVENTION

The invention relates to the operation of a mobile device near the edge of the coverage offered by their home network, and in particular to method and apparatus for minimising the roaming of the mobile device in these areas.

### BACKGROUND TO THE INVENTION

Radio waves do not respect country borders. As a result, it is possible for a mobile subscriber who lives near a border between two countries to be using their mobile device at home (in their home country), but actually be connected to a foreign network in the neighbouring country as if they were travelling abroad (i.e. they are roaming).

The mobile device may register with or attach to a foreign network even though coverage from the home network is actually still available. Once the mobile device has attached to the foreign network, it can sometimes take a long time for the mobile device to re-register with or reconnect to the home network. This results in unreasonable roaming costs for the mobile subscriber and operator, particularly if the subscriber has not in fact left their home country.

For a legitimate outbound mobile device (i.e. one that is crossing the border and that will need to roam to a foreign network in order to maintain service), this can mean that roaming costs are increased, as the mobile device may attach to the foreign network earlier than necessary.

A similar problem occurs for an inbound roaming mobile device, in that the mobile device can stay connected to the foreign network for some time after the subscriber has returned to their home country (and the coverage of their home network). Again, this results in unnecessary roaming charges for both the subscriber and the home network operator.

Each of these scenarios can lead to a considerable revenue loss for the home network operator and an increase in customer complaints.

These problems are particularly significant in areas where there is a land border between two countries, typically meaning that there is no clear demarcation between service areas provided by the home network and the foreign network. It is often the case that the coverage of one or more of these networks will extend into the geographic area of the other country.

Likewise, networks exist that only cover a part of a country, and due to this limited coverage, it is necessary for subscribers of that network to roam onto other networks in order to maintain coverage for the subscribers wherever they are in the country (this is referred to herein as ‘national roaming’, but it will be appreciated that from the home network's point of view there is no difference between ‘national roaming’ and ‘international roaming’). In some cases a subscriber can be charged the same amount whichever network they are on in their home country, but the operator of the subscriber's home network has to pay the other networks a significant amount for this national roaming. Thus, delays in a subscriber returning to the home network can increase the costs for the operator of the small network.

### SUMMARY OF THE INVENTION

Conventionally a mobile device that is roaming (i.e. connected to a network that is not the home network of the mobile device) performs a search for a signal from the home network of the mobile device (or a signal from a network that is higher in a list of preferred networks stored in the mobile device than the current serving network), and if a suitable network is found, the mobile device registers with (i.e. connects to) that network. This search is performed periodically, but it is only carried out when the mobile device is idle (i.e. when it is not using any network services, such as voice, data, messaging, etc.). Unfortunately, mobile devices often run or use various applications and services that prevent or substantially delay the mobile devices from becoming idle, and thus the home network search cannot be performed. Therefore there is a need for a solution that allows a mobile device that is roaming on to another network to reconnect to a home network quicker than current techniques allow.

According to a first aspect of the invention, there is provided a method of initiating a search for a home network in a mobile device that is attached to a network other than a home network of the mobile device, the method in an apparatus comprising determining whether the mobile device is in a part of said other network where there may be coverage from the home network; and if the mobile device is determined to be in a part of said other network where there may be coverage from the home network, sending a message to said other network in order to change one or more of a voice, messaging and/or data service available to the mobile device, such that the mobile device can enter an idle state and perform a search for the home network.

According to a second aspect, there is provided a computer program product comprising a computer readable medium having computer readable code embodied therein, the computer readable code being configured such that, on execution by a suitable computer or processor, the computer or processor is caused to perform the method described above. The computer readable medium can be non-transitory.

According to a third aspect, there is provided an apparatus for use in initiating a search for a home network in a mobile device that is attached to a network other than a home network of the mobile device, the apparatus being configured to determine whether the mobile device is in a part of said other network where there may be coverage from the home network; and send a message to said other network in order to change one or more of a voice, messaging and/or data service available to the mobile device, such that the mobile device can enter an idle state and perform a search for the home network if the mobile device is determined to be in a part of said other network where there may be coverage from the home network.

In some embodiments the apparatus can comprise processing circuitry that is configured to determine whether the mobile device is in the part of said other network where there may be coverage from the home network; and interface circuitry that is configured to send the message to said other network in order to change one or more of a voice, messaging and/or data service available to the mobile device, such that the mobile device can enter an idle state and perform a search for the home network if the mobile device is determined to be in a part of said other network where there may be coverage from the home network.

According to a fourth aspect there is provided a method, comprising, in an apparatus, initiating a search for a home network in a mobile device that is attached to a network other than a home network of the mobile device as described above; and, in said network other than the home network of the mobile device, receiving the message from the apparatus, and changing the one or more of a voice, messaging and/or data service available to the mobile device.

According to a fifth aspect, there is provided a system, the system comprising an apparatus as described above; and a node in said network other than the home network of the mobile device, said node being configured to receive the message from the apparatus, and change the one or more of a voice, messaging and/or data service available to the mobile device.

### BRIEF DESCRIPTION OF THE DRAWINGS

The invention will now be described, by way of example only, with reference to the following drawings, in which:

FIG. 1 illustrates the overlap in coverage between two networks;

FIG. 2 is a block diagram showing elements of a home network and a visited network;

FIG. 3 is a flow chart illustrating a method performed by an apparatus in accordance with an aspect of the invention;

FIG. 4 is a block diagram of an exemplary apparatus according to an aspect of the invention;

FIG. 5 is a flow chart illustrating an exemplary method of determining whether a mobile device might have coverage from a home network;

FIG. 6 is a state machine illustration of an exemplary technique for determining the location of a mobile device;

FIG. 7 is a flow chart illustrating an exemplary method according to an embodiment of the invention; and

FIG. 8 is a state machine illustration of another exemplary method according to an embodiment of the invention.

### DETAILED DESCRIPTION OF THE PREFERRED EMBODIMENTS

The invention will be described below with reference to the operation of a mobile device at or near the edge or border of the home network for the mobile device (or rather for the subscriber associated with the mobile device—the terms ‘subscriber’ and ‘mobile device’ are used interchangeably herein), and thus at or near a border between the home network and another network, which is referred to herein generally as a ‘non-home’ network or a ‘visited’ network (in the case where the mobile device is connected to that network). It will be appreciated that this edge or border can occur at or near an international border between two countries, but also within a country where the home network does not provide complete coverage to subscribers and mobile devices in that country.

In addition, although the invention will be primarily described with reference to a home network and visited network that both have a Universal Mobile Telecommunications System (UMTS)-based architecture, it will be appreciated by those skilled in the art that the invention can be applied to networks operating according to other types of second, third, fourth and subsequent-generation technologies, including Long Term Evolution (LTE). It will also be appreciated that the home network and the visited network can operate according to different communication technologies/standards (i.e. it is not necessary for either or both of the networks to be based on the same technology or standard).

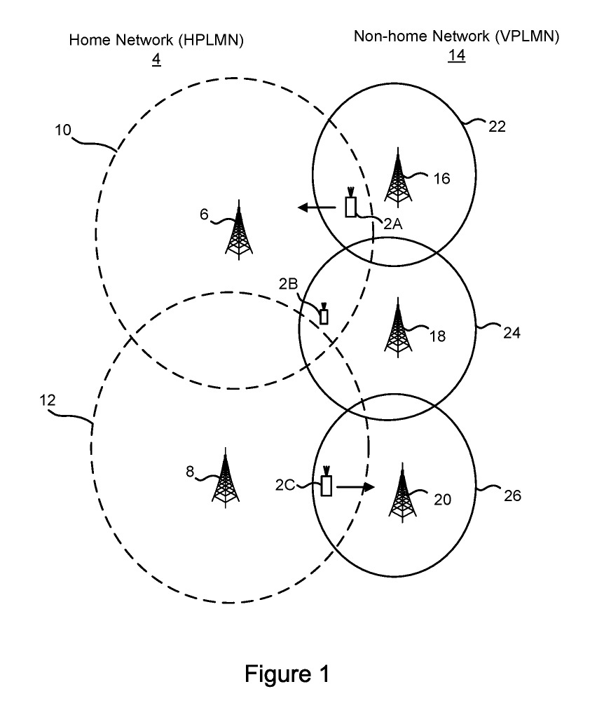

FIG. 1 shows three mobile devices 2 that are located near the edge or border of a home network 4. The edge or border of the home network 4 is where mobile devices 2 can no longer receive radio signals (or radio signals of sufficient quality) from the base stations (e.g. NodeBs or eNodeBs) of the home network 4. The home network 4 for the mobile devices 2 is also referred to as the Home Public Land Mobile Network (HPLMN) for those devices 2.

Part of the network architecture of the home network 4 is shown in FIG. 1. Specifically, two base stations 6, 8 are shown, each defining a respective cell having a coverage area 10, 12 illustrated by a dashed line.

Part of another network 14 operated by a different network operator is also shown in FIG. 1. This network 14 is a ‘non-home’ network for the mobile devices 2, and the mobile devices 2 can roam to this network 14, if necessary (for example if the radio signals from the home network 4 cannot be received or received with a sufficient quality. When a mobile device 2 is connected to the network 14 (i.e. roaming on to network 14), the network 14 is referred to as the “visited network” or the VPLMN (Visited Public Land Mobile Network).

Three base stations (e.g. NodeBs or eNodeBs) 16, 18, 20 that form part of the architecture of the non-home network 14 are shown in FIG. 1. Each of the base stations 16, 18, 20 defines a respective cell having a coverage area 22, 24, 26 illustrated by a solid line.

It can be seen that the coverage areas 10, 12, 22, 24, 26 of the cells overlap, and thus there are areas in which the coverage of the home network 4 overlaps with the coverage of the non-home network 14. This overlapping area can occur at or near a geographical boundary, such as an international border, or more generally at the geographical edge of the coverage area of the home network 4.

It will be appreciated that FIG. 1 only illustrates a small part of each network 4, 14, and that there may be many more base stations and associated cells near the edge of the home network 4 than those shown. Moreover, it will also be appreciated that there may be multiple networks operating in these areas, each operated by a respective network operator that overlap with the home network 4 and/or non-home network 14. However, only one of these networks will be the “home network” of the mobile devices 2.

Each of the three mobile devices 2 illustrate one of the problems to be overcome by the invention. Mobile device 2A has been in a geographical area where there is no coverage from home network 4, and thus mobile device 2A has been (intentionally) roaming in the non-home network 14, but the mobile device 2A is now moving back towards the home network 4. As a result of this movement, the mobile device 2A, which is currently registered with/connected to the non-home network 14 as a roaming device, has just entered the coverage area 10 of base station 6 in the home network 4. As described above, it is desirable for this device 2A to register with the home network 4 as soon as possible, in order to reduce roaming charges.

Mobile device 2B represents a device that is located within the geographical coverage area of the home network 4, and is within the coverage area of a cell in both the home network 4 (cell 10) and the non-home network 14 (cell 24). As described above, it is desirable for this device 2B to remain registered with the home network 4 whenever possible, or to return to the home network 4 as soon as possible, in order to avoid or minimise roaming charges.

Mobile device 2C is located in the coverage area of the home network 4 but is moving towards the edge of the home network 4. As a result of this movement, the mobile device 2C, which is registered with the home network 4, has just entered the coverage area 26 of base station 20 of the non-home network 14. Although the movement of mobile device 2C will result in the device 2C leaving the coverage area of the home network 4 completely (and therefore becoming a roaming device of the non-home network 14), it is desirable for the device 2C to remain registered with the home network 4 for as long as possible, or to return to the home network 4 if the mobile device 2C roams to the non-home network 14 when coverage from the home network 4 is still available, in order to reduce roaming charges.

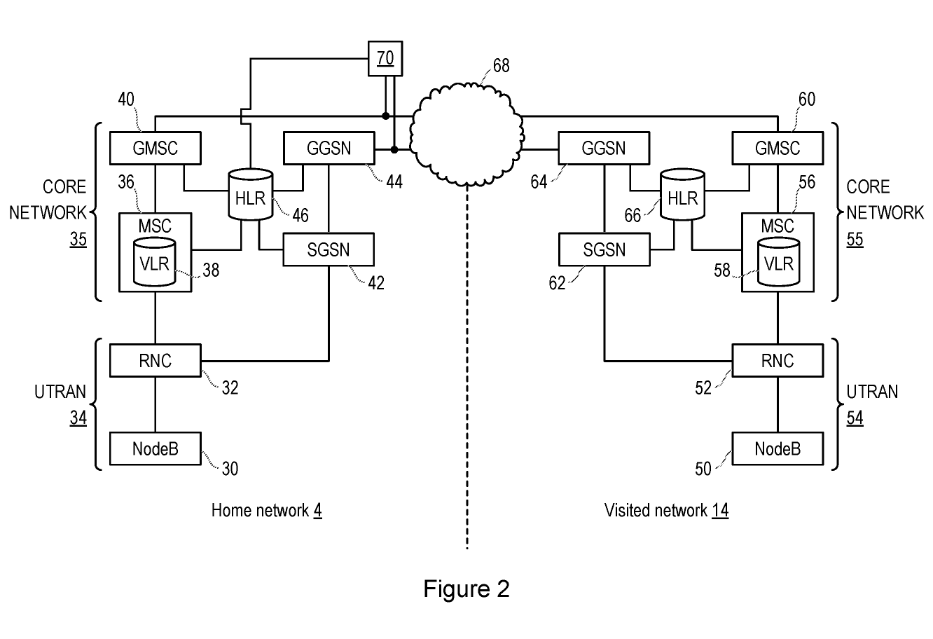

FIG. 2 is a block diagram showing elements of two networks according to the UMTS architecture. The UMTS architecture is well-known in the art, and thus only brief details of the elements of the networks are described below. It will also be noted that networks generally include many instances of the elements described below, but only a single instance of each element is shown in FIG. 2 for ease of illustration. In FIG. 2, the two networks are labelled as home network 4 and non-home/visited network 14.

Thus, the home network 4 comprises a plurality of base stations 30 (known as NodeBs in UMTS and eNodeBs in LTE) that provide the air interface to mobile devices 2 (known as user equipments, UEs in UMTS and LTE). Each base station 30 controls or has one or more cells, each with a respective cell identity, denoted CellID. In a circuit-switched domain, a group of base stations 30 is referred to as a location area, which is uniquely identified by a location area code (LAC). In a packet-switched domain, a group of base stations 30 is referred to as a routing area, which is uniquely identified by a routing area code (RAC).

Multiple NodeBs 30 are controlled by a Radio Network Controller (RNC) 32 that provides various control functions, such as radio resource control, handover control, admission control, etc. The RNCs 32 and NodeBs 30 form the Universal Terrestrial Radio Access Network (UTRAN) 34. The RNCs 32 in the UTRAN 34 connect to the core network 35. In the case of LTE, which uses the evolved-UTRAN (E-UTRAN), the eNodeBs perform the functions of both the UTRAN NodeBs and the RNCs.

On the circuit-switched side, the core network 35 comprises a Mobile Switching Centre 36 that is connected to the RNCs 32. The MSC 36 manages circuit-switched calls to UEs 2 in the network 4. The MSC 36 includes or is associated with a Visitor Location Register 38 that stores information about all mobile devices that are currently registered with the MSC 36 (e.g. the CellID and location area of the mobile device). Whenever the MSC 36 is notified of a new mobile device in its network (such as when a mobile device 2 registers with the network 4), the MSC 36 adds an appropriate record to the VLR 38.

A Gateway MSC (GMSC) 40 is connected to the MSC 36 and this provides the interface between the circuit-switched part of the core network 35 and external networks (such as network 14).

On the packet-switched side, the core network 35 comprises a Serving GPRS (General Packet Radio Service) Support Node (SGSN) 42 that is connected to the RNCs 32. The SGSN 42 is responsible for mobility management and session management for mobile devices 2 in the network 4, and in particular is responsible for the management of the data ‘pipes’ to the mobile devices 2, which are known as PDP (packet data protocol) contexts. As part of the mobility management, the SGSN 42 maintains information on the location (e.g. service area, routing area, CellID) of mobile devices 2 that are currently registered with the SGSN 42 (similar to the VLR 38 on the circuit-switched side).

A Gateway GPRS Support Node (GGSN) 44 is connected to the SGSN 42 and this provides the interface between the packet-switched part of the core network 35 and external networks (such as network 14).

The core network 35 also includes a Home Location Register (HLR) 46 that is connected to the other nodes in the core network 35. The HLR 46 stores information about each mobile device 2/subscriber to the home network 4, including the location of the mobile device 2 (e.g. CellID, location area, MSC/VLR, or CellID, routing area, service area, SGSN).

In the case of a fourth generation network (e.g. LTE) using the E-UTRAN, the core network 35 includes a Mobility Management Entity (MME) that is responsible for subscriber and session management in the network, and a Home Subscriber Server (HSS), which has a similar function to the HLR 46 in the UMTS network.

The structure of the visited network 14 shown in FIG. 2 is similar to that of the home network 4. Thus, the visited network 14 comprises base station (e.g. NodeB) 50, RNC 52, UTRAN 54, core network 55, MSC 56, VLR 58, GMSC 60, SGSN 62, GGSN 64 and HLR 66 which each correspond respectively to the base station (e.g. NodeB) 30, RNC 32, UTRAN 34, core network 35, MSC 36, VLR 38, GMSC 40, SGSN 42 GGSN 44 and HLR 46 in the home network 4.

The home network 4 and visited network 14 are interconnected via network 68, which could be the Internet or any other type of network.

When a mobile device 2 that is a subscriber of the home network 4 is roaming in visited network 14, MSC 56 will create a record in the VLR 58 indicating the location of the mobile device 2. In addition, the MSC 36 provides a Location Update (LU) signal to the home network 4 of the mobile device 2 to inform the home network 4 where the mobile device 2 is. This Location Update signal is used to update the HLR 46 in the home network 4, so that the home network 4 can determine where its mobile subscriber/device 2 is located. Similar signals occur in E-UTRAN, in which a location update signal is used to update the HSS in the home network.

As described above, a mobile device 2 that is roaming (e.g. that is connected to visited network 14) performs a search for a signal from the home network 4 (or a signal from a network that is higher in a list of preferred networks stored in the mobile device 2 than the current serving network 14). If a suitable network is found, the mobile device attaches or connects to that network.

This search, which is also known in some types of networks as a Higher Priority PLMN (HPPLMN) search, is performed periodically according to a timer value. This timer value is set for a mobile device 2 by the network, and can typically range from 6 minutes to 30 minutes. Thus, when a mobile device 2 is roaming, the mobile device 2 monitors the timer value, and when the timer expires, the mobile device 2 performs a search for a higher priority PLMN (e.g. the home network 4). However, the search for a home network 4 is only performed when the mobile device 2 is idle, i.e. when the mobile device 2 is not using any network services, such as voice, data, messaging, etc. If the timer expires and the mobile device 2 has an active voice call or an active data session, then the timer remains latched until the voice call or data session has ended and the search for the home network 4 can be performed. If the mobile device 2 is still attached to the (or another) visited network 14 after the search, the timer restarts.

However, a problem exists that mobile devices 2 often run or use various applications and services that, either alone or in combination, maintain or require a continuous connection to the network, and thus the mobile devices are prevented from or substantially delayed in becoming idle, and thus the home network search cannot be performed. This is of particular issue in the scenarios shown in FIG. 1 where the mobile device 2 is roaming on another network 14 but is in an area where there is coverage from the home network 4.

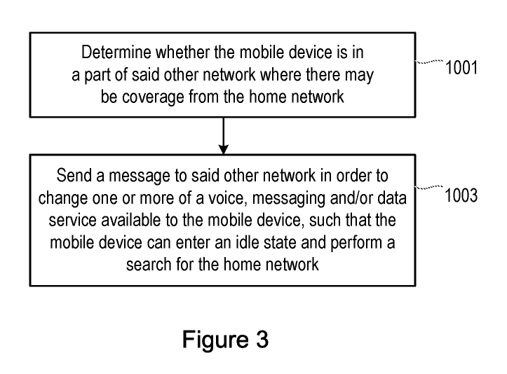

Therefore the invention provides a technique for reducing the time taken to reconnect or reattach a mobile device 2 to its home network when there might be coverage from the home network 4. FIG. 3 is a flow chart illustrating a method according to the invention of initiating a reattachment process (i.e. a search for a home network 4) in a mobile device 2 that is attached or connected to a network other than the home network 4 of the mobile device 2 (i.e. the visited network 14).

In a first step, step 1001, it is determined whether the mobile device 2 is in a part of the visited network 14 where there may be coverage from the home network 4. Two exemplary techniques for performing step 1001 are described below.

If the mobile device 2 is determined to be in a part of the visited network 14 where there may be coverage from the home network 4, a message is sent to the visited network 14 in order to change one or more of the services available to the mobile device 2. This change in the one or more of the services available is intended to cause or allow the mobile device 2 to enter an idle state, which therefore allows the mobile device 2 to perform a search for the home network 4.

The change to the one or more of the services available to the mobile device 2 can comprise blocking or removing the one or more services. If the changed service is a service that is ‘active’, i.e. currently being used by the mobile device 2, then blocking or removing this service can cause the mobile device 2 to return to an idle state (assuming that the mobile device 2 does not have any other ‘active’ services) and thus allow the mobile device 2 to perform the home network search when the timer expires.

The services available to the mobile device 2 include voice, short messaging services (SMS), and various data services, such as multimedia messaging services (MMS), wireless application protocol (WAP) services and Internet services. The services most likely to be in use for a significant length of time, and therefore preventing a mobile device 2 from becoming idle are voice services and data services. Thus, in some embodiments the message sent in step 1003 can be a message that changes the voice and/or data services for the mobile device 2.

Since a user may be actively using the mobile device 2 during a voice call, it may be deemed undesirable (from the point of view of the user experience) to disrupt the voice call, and thus in some embodiments, it is preferable the message sent in step 1003 is not used to change the voice services available to the mobile device 2. Alternatively, the priority may be to reduce roaming costs for the subscriber, and thus in other embodiments the message sent in step 1003 can be used to change (e.g. remove or block) voice services available to the mobile device 2.

In more preferred embodiments, since data services are the services most likely to be preventing a mobile device 2 from becoming idle (e.g. since data services can be used by the mobile device 2 in the background, i.e. without being actively initiated by the user or after a user has exited an application), the message 1003 is used to change the data services available to the mobile device 2. In some embodiments, the message sent in step 1003 can be used to change (e.g. block or remove) all data services, e.g. including MMS, WAP and the Internet, but in more preferred embodiments, since the Internet service is the service that is most often in use by applications or services in a mobile device 2 and thus the service that prevents the mobile device 2 from becoming idle, step 1003 comprises sending a message to the visited network 14 in order to change (e.g. block or remove) the Internet service for the mobile device 2, while leaving the other data services unaffected.

In some embodiments, the message sent in step 1003 can cause the removal of a PDP context associated with the relevant data service (or PDP contexts associated with all data services). In some embodiments, the message sent in step 1003 is a Mobile Application Part (MAP) message or a Diameter message. In some preferred embodiments, the message sent in step 1003 is a MAP deleteSubscriberData message that causes the deletion of the PDP context identities associated with the mobile device 2. In some embodiments, the MAP deleteSubscriberData message is sent to the SGSN 62 in the visited network 14. In some alternative preferred embodiments, the message sent in step 1003 is a MAP insertSubscriberData message that causes the addition of one or more services, but does not add a service requiring PDP contexts (e.g. the Internet). For example the MAP insertSubscriberData message can add a service such as voice or MMS, but not a data service such as the Internet. In some embodiments, the MAP insertSubscriberData is sent to the SGSN 62 in the visited network 14. Where an insertSubscriberData message is received that does not list a service that is currently active for the mobile device 2, the insertSubscriberData message will result in that unlisted service being removed. In this way, if, prior to the sending of the insertSubscriberData message that does not add a data service, the mobile device 2 has a PDP context associated with a data service, the insertSubscriberData message will result in the data service being removed for the mobile device 2. The message sent in step 1003 may be a MAP message if the visited network 14 is any type of second or third generation network (e.g. GSM, UMTS).

In some other preferred embodiments, the message sent in step 1003 is a Diameter Delete Subscriber Data Request message that causes the deletion of the PDP context identities associated with the mobile device 2. In some embodiments, the Diameter Delete Subscriber Data Request message is sent to a Mobility Management Entity (MME) in the visited network 14. In some alternative preferred embodiments, the message sent in step 1003 is a Diameter Insert Subscriber Data Request message that causes the addition of one or more services, but does not add a service requiring PDP contexts (e.g. the Internet). For example the Diameter Insert Subscriber Data Request message can add a service such as voice or MMS, but not a data service such as the Internet. In some embodiments, the Diameter Insert Subscriber Data Request message is sent to a MME in the visited network 14. Where a Diameter Insert Subscriber Data Request message is received that does not list a service that is currently active for the mobile device 2, the Insert Subscriber Data Request message can result in that unlisted service being removed. In this way, if, prior to the sending of the Insert Subscriber Data Request message that does not add a data service, the mobile device 2 has a PDP context associated with a data service, the Insert Subscriber Data Request message will result in the data service being removed for the mobile device 2. The message sent in step 1003 may be a Diameter message if the visited network 14 is any fourth or subsequent (e.g. fifth) generation network (e.g. LTE, LTE Advanced).

In some embodiments, step 1003 may only be performed when the timer is about to expire or has expired, in which case the mobile device 2 will be able to perform the search for the home network 4 shortly after the message is sent in step 1003. The home network 4 will be aware of the timer value set for the mobile device 2, and the home network 4 will also know when the mobile device 2 started roaming, so it is straightforward to determine when the timer is about to expire and to send the message to the visited network 14 (if the mobile device 2 is in a part of the visited network 14 where there might be coverage from the home network 4). In fact, it is expected that the majority of roaming mobile devices 2 will have been roaming for longer than the timer period and that the mobile device 2 will not have been in an idle mode during that time (due to the data service being used continuously by applications in the mobile device 2), in which case the mobile device 2 will attempt a search for a home network 4 as soon as step 1003 is performed and the data service is blocked or removed.

As noted above, the search for the home network 4 performed by the mobile device 2 can be a HPPLMN search. As is known, a mobile device 2 will have a list of “preferred” or “priority” networks or network operators to which the mobile device 2 should attach, if multiple networks are available in a particular area. This list will include at least a home network 4 (i.e. HPLMN), and optionally one or more Equivalent Home Networks (EHPLMNs) that the mobile device 2 could connect to. Usually, the mobile device 2 will have the home network 4 at the top of this list (i.e. as the network with the highest priority). Thus, on expiry of the HPPLMN search timer, the mobile device 2 executes a background search for signals from the home network 4 (i.e. HPLMN) or any EHPLMNs other than the network the mobile device 2 is registered with. If the mobile device 2 detects a signal from the home network 4 (or a higher priority EHPLMN), the mobile device 2 attaches to that network. The HPPLMN timer can be deactivated if the mobile device 2 is connected to the home network 4, but the timer can remain active if the mobile device 2 is connected to an EHPLMN.

The above method can be performed by an apparatus 70 that is placed in, connected to or otherwise associated with the home network 4 for the mobile device 2. An exemplary apparatus 70 is shown in FIG. 2 that is connected to several elements of the home network 4.

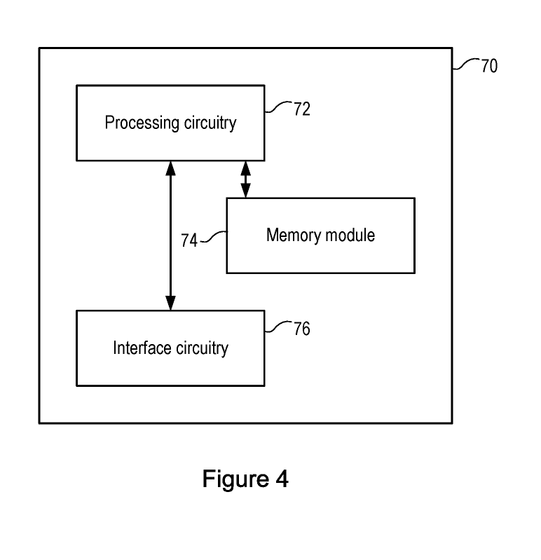

FIG. 4 is a block diagram of an exemplary apparatus 70 according to an aspect of the invention. As described above, the apparatus 70 can be placed in a home network 4, be connected to a home network 4 or otherwise be associated with a home network 4 (and for example be located in network 68 rather than in home network 4). This enables the apparatus 70 to monitor various signals that are received by the home network 4 from a visited network 14, or exchanged with the visited network 14 while a mobile device 2 is roaming in the visited network 14. The apparatus 70 can also be used to send the signal or signals to the visited network 14 in order to change or remove a service from the roaming mobile device 2 in order to enable the mobile device 2 to perform a home network search.

The apparatus 70 comprises processing circuitry 72 that controls the operation of the apparatus 70, and in particular that controls the apparatus 70 to operate according to the techniques and methods described herein. The processing circuitry 72 can comprise any suitable processing circuitry, including one or more processors or cores, and any circuitry required to support or enable the control of the operation of the, or parts of the, apparatus 70.

The apparatus 70 also comprises a memory module 74 that can store computer program code or other code that is executable by the processing circuitry 72. The code can be configured such that the apparatus 70 performs any of the above described methods or techniques when the processing circuitry 72 executes the code.

The apparatus 70 further comprises interface circuitry 76 that enables the apparatus 70 to connect to the home network 4 in order to monitor the various signals that are received by the home network 4 from a visited network 14, or exchanged with the visited network 14 while a mobile device 2 is roaming in the visited network 14, and that enables the apparatus 70 to send the signal or signals to the visited network 14 as described above. The interface circuitry 76 can enable connections to one or multiple points and/or one or multiple nodes in the home network 4 as required. In the embodiment shown in FIG. 2, the apparatus 70 is connected to (or to the inputs to) the GMSC 40, GGSN 44 and HLR 46, but it will be appreciated that this is merely an example. In the case of a E-UTRAN-based network, the apparatus 70 can be connected to (or to the inputs to) an MME, a HSS and a Packet Data Network (PDN) Gateway (P-GW), but it will be appreciated that this is also merely an example.

The interface circuitry 76 can operate or be compatible with one or more signalling protocols or interface protocols (for example those used to exchange signals between nodes in a core network, or between different core networks).

In some embodiments, for example as shown in FIG. 2, the apparatus 70 can be separate, stand-alone node in the home network 4, but in other embodiments the apparatus 70 (or the functionality provided by the apparatus 70) can be implemented as part of one or more of the existing nodes in the home network 4 (e.g. as part of the GMSC 40, GGSN 44 and/or HLR 46 in the case of a UMTS network, or as part of the MME, HSS and/or P-GW in a E-UTRAN based network).

Finally, it will be appreciated that FIG. 4 only illustrates the components of the apparatus 70 required to describe the invention, and a practical implementation of an apparatus 70 according to the invention may include further components to those shown in FIG. 4.

In order for the apparatus 70 to determine if a roaming mobile device 2 is in a part of a visited network 14 where there might be coverage from the home network 4, it is necessary to have some information about the architecture and cell structure of the visited network 14. This information can be in the form of cell identities, location areas, routing areas, MSC identities and SGSN identities (or MME identities) associated with locations where there may be coverage from the home network 4. This information can be obtained, for example, by using a probe device and observing information contained in location update messages sent by the visited network 14 to the home network 4 as the probe device is moved around the visited network 14. This technique for determining information on the architecture and cell structure of the visited network 14 is described in more detail in GB 2470194, and thus further details are not provided herein.

The home network coverage information can be stored in memory module 74 of apparatus 70. The information stored in the memory module 74 will provide a map of the coverage provided to mobile devices by the home network 4 and any non-home networks 14 near a border or edge of home network 4. As indicated in GB 2470194, this home network coverage information can include an SS7 GT (Global Title) address of VLRs 58 in the non-home network 14, SGSN identities, as well as the Location Area Codes (LACs), Routing Area Codes (RACs), Service Area Codes (SACs) and CellIDs of base stations 50 as described herein. This home network coverage information can then be used to identify areas where mobile devices 2 may have coverage from the home network 4.

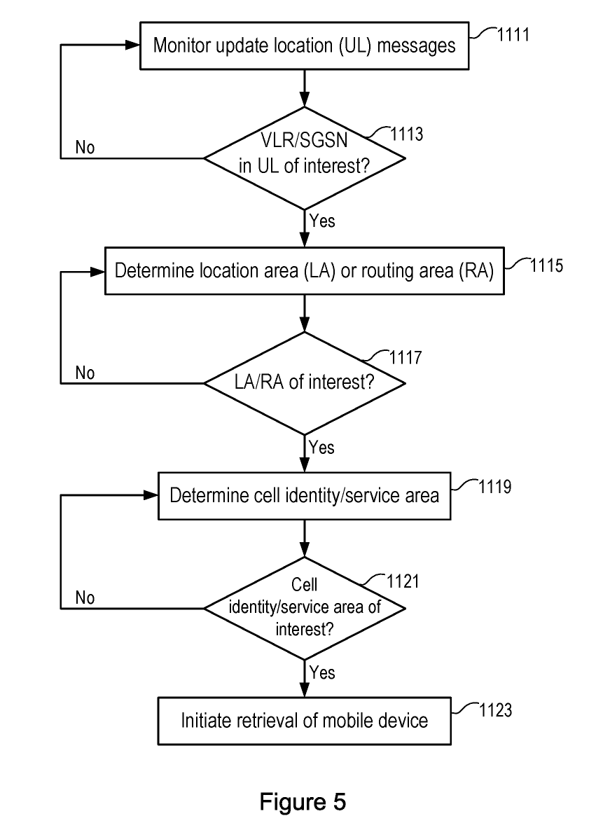

The flow chart shown in FIG. 5 illustrates an exemplary method of determining whether a mobile device might have coverage from a home network 4. This exemplary method can be performed by the apparatus 70 by monitoring update location messages sent by the visited network 14 to the home network 4.

Thus, in a first step, step 1111, signals from the visited network 14 to the home network 4 are monitored to identify location update messages sent regarding subscribers of the home network 4. In particular embodiments, step 1111 comprises monitoring messages sent as part of the MAP SS7 protocol, and in particular monitoring for MAP mobility management ‘updateLocation’ and ‘updateGprsLocation’ dialogues for subscribers that are roaming. In other particular embodiments, step 1111 comprises monitoring messages sent as part of the Diameter protocol, and in particular monitoring for Diameter ‘Update Location Request’ and ‘Update Location Acknowledgement’ messages for subscribers that are roaming. The information in these messages allows the apparatus 70 to determine when the mobile device 2 is attached to a VLR 58, SGSN 62 or MME that is known to have overlapping coverage with the home network 4.

On receipt of a location update message concerning a subscriber of the home network 4 that is roaming in visited network 14, the identity of the VLR 58, SGSN 62 or MME in the visited network 14 that the mobile device 2 is connected to is determined from the content of the location update message. In particular, the identity of the VLR 58, SGSN 62 or MME in the visited network 14 is listed in an address field of the location update message. The location update message can also include identifiers for any PDP contexts (for example for Internet access, MMS, WAP, etc.) established for the mobile device 2 in the visited network 14. This information is useful when sending the message according to step 1003 above as the PDP context(s) to be blocked or removed can be identified in the message (e.g. identified in a MAP deleteSubscriberData message or Diameter Delete Subscriber Data Request message) or the PDP context(s) to be maintained can be identified in the message (e.g. identified in a MAP insertSubscriberData message or Diameter Insert Subscriber Data Request message, while an existing, e.g. Internet PDP context, is not identified).

Next, it is determined whether the identified VLR 58, SGSN 62 or MME is a VLR, SGSN or MME of interest (step 1113). In other words, it is determined whether the identified VLR 58, SGSN 62 or MME is associated with any cells where there might be coverage from the home network 4. This step 1113 is carried out by comparing the identified VLR 58, SGSN 62 or MME to the home network coverage information stored in the apparatus 70.

If the VLR 58, SGSN 62 or MME is not of interest (i.e. not associated with any cells where there might be coverage from the home network 4), the method returns to step 1111 and repeats for the next location update message.

If the VLR 58, SGSN 62 or MME is of interest (i.e. is associated with cells where there might be coverage from the home network 4), the method moves to step 1115 in which the location area (LA) or routing area (RA) is determined. As this information is not contained in the location update message, in this step the apparatus 70 sends (or triggers a node in the home network 4 to send) a message or signal to the visited network 14 to request information on the location area or routing area of the mobile device 2. The visited network 14 responds to this request with a message that indicates the location area or routing area of the mobile device 2.

In particular embodiments, the apparatus 70 can send or cause to be sent a MAP ‘anyTimeInterrogation’ message (also referred to herein as an ATI message) to obtain this information. In response to receiving the ATI message the HLR 66 in the visited network 14 replies with a MAP ‘anyTimeInterrogation’ response (also referred to herein as an ATI response), the content of which indicates the location area or routing area of the mobile device 2. The ATI response allows the mobile device's location to be determined to a specific location area identity, LAI (location area and cell identity) or service area identity, SAI (location area and service area code).

Next, it is determined in step 1117 whether the location area or routing area is of interest (i.e. is associated with cells where there might be coverage from the home network 4). Step 1117 is similar to step 1113 and thus comprises comparing the location area or routing area to the home network coverage information.

If the location area or routing area is not of interest (i.e. not associated with any cells where there might be coverage from the home network 4), the method returns to step 1115 and repeats after a time interval. This time interval can be predetermined and is set to allow time for movement of the mobile device 2 through the visited network 14 such that the mobile device 2 might change location area or routing area (in which case the outcome of a subsequent request might indicate that the mobile device 2 is now in a location area or routing area of interest).

If in step 1117 the location area or routing area is of interest, the method moves to step 1119 in which the cell identity (e.g. CellID) or service area of the mobile device 2 is determined. This information can be provided in the response (e.g. the ATI response) received as part of step 1115, and thus step 1119 can comprise extracting that information from the response message.

Next, in step 1121, it is determined whether the cell identity or service area is of interest (i.e. there might be coverage from the home network 4). This step can comprise comparing the cell identity or service area of the mobile device 2 indicated in that response message to the home network coverage information to determine if the cell identity or service area corresponds to an identity or area where there may be coverage from the home network 4.

If the cell identity or service area is not of interest, the method returns to step 1119 and repeats after a time interval. In this case, repeating step 1119 can comprise sending a new request to the visited network 14 for the location area or routing area information for the mobile device 2 (since the response to this request also indicates the cell identity or service area). This time interval, like the time interval referenced above with respect to step 1115, can be predetermined and is set to allow time for movement of the mobile device 2 through the visited network 14 such that the mobile device 2 might change cell or service area (in which case the outcome of the subsequent request (e.g. ATI request) might indicate that the mobile device 2 is now in a cell or service area of interest. In view of the relative sizes of location/routing areas and cells/service areas, the time interval used for repeating step 1119 can be shorter than the time interval used for repeating step 1115. The longer and shorter time intervals is useful in order to avoid flooding the visited network 14 with a large number of MAP messages. In addition, the longer and shorter intervals cause the rate of searching/scanning for the mobile device's location to be increased as the location of the mobile device 2 becomes more interesting.

If the cell identity or service area is of interest, then the mobile device 2 is in part of the visited network 14 where there may be coverage from the home network 4, and thus retrieval of the mobile device 2 to the home network 4 can be attempted or initiated (step 1123, which corresponds to step 1003 of FIG. 3).

In some embodiments, the ATI response can indicate the state of the mobile device 2, i.e. ‘idle’ or ‘busy’, and the reason for the ‘busy’ state, e.g. that the mobile device 2 has an active voice call. In that case, if it is not desired to interrupt a voice call by the mobile device 2, this information can be used to delay executing step 1123/1003 until an ATI response indicates that the mobile device 2 is not ‘busy’ with a voice call. Alternatively, on receipt of an ATI response indicating that the mobile device 2 is busy with an active voice call, the transmission of the message in step 1003/1123 can be delayed by a certain time interval. The length of the time interval can be preset or variable, and for example can be a value in the range of 0 to 10 minutes. In another alternative, on receipt of an ATI response in step 1115/1117 indicating that the mobile device 2 is busy with an active voice call, the transmission of the message in step 1003/1123 is not performed, and instead the method repeats step 1115 after another time interval (e.g. by sending an ATI message to the visited network 14 to request information on the location area or routing area of the mobile device 2) to check that the mobile device 2 is still in a location area and/or routing area of interest (step 1117) and that the mobile device 2 is now idle (i.e. not in a ‘busy’ state due to an active voice call). This time interval can be referred to as a “poll interval time”, and can be a relatively short time duration, e.g. in the range of 0 to 10 minutes. If the mobile device 2 is found to still be in a location area and/or routing area of interest and the mobile device 2 is now idle, the method can proceed (e.g. by checking the cell identity/service area of interest (steps 1119 and 1121) and initiating retrieval of the mobile device 2 (step 1123)).

It will be appreciated that while the later steps in the method (e.g. steps 1115-1121) are being performed, it is possible that subsequent location update messages sent by the visited network 14 to the home network 4 can indicate that the mobile device 2 is now associated with an uninteresting VLR 58, SGSN 62 or MME. In this case, rather than repeat step 1115 or 1119 (as appropriate), the method returns to step 1111. Likewise, while step 1119 is being repeated, it is possible that a subsequent response (e.g. ATI response) can indicate that the mobile device 2 is now associated with an uninteresting location are or routing area. In this case, rather than repeat step 1119, the method returns to step 1115.

In the above embodiments, the complete location area or service area (i.e. including the cell identity) is used to decide whether to attempt to retrieve the mobile device 2. This can be the case where, for example, the area covered by a location area does not completely overlap with the home network's radio coverage, e.g. in rural areas with a light population density which will have larger location areas. For more densely populated areas such as cities, the location area will generally be smaller and the cell density much higher. In these cases, the location area or routing area alone (i.e. without the cell identity) might be sufficient to trigger the retrieval process, in which case steps 1119 and 1121 can be omitted.

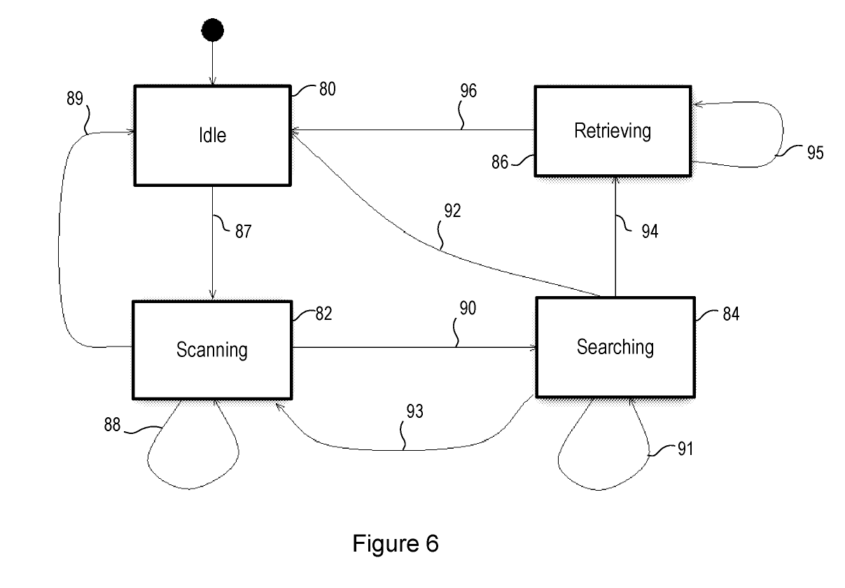

FIG. 6 is a state machine illustration of the location scanning method shown in FIG. 5. Four states or modes are shown in FIG. 6, an idle state 80, a scanning state 82, a searching state 84 and a retrieving state 86.

Idle state 80 corresponds to steps 1111 and 1113 in FIG. 5 and thus in the idle state 80 the apparatus 70 is monitoring location update messages to determine if the mobile device 2 is connected to a VLR 58, SGSN 62 or MME of interest. If the mobile device 2 is connected to a VLR 58, SGSN 62 or MME of interest, the state machine moves to the scanning state 82 (indicated by arrow 87) in which the apparatus determines the location area or routing area of the mobile device 2 by sending request messages (e.g. ATI messages) to the visited network 14 (corresponding to step 1115 of FIG. 5). These request messages can be sent periodically with a relatively long time interval between requests. For example the time interval between requests can be longer than typical values for the HPPLMN search timer (which has a value in the range of 6 minutes to 30 minutes), of the order of 1 to 5 times the length of the HPPLMN timer value.

The state machine remains in the scanning state 82 while location update messages are received that indicate that the mobile device 2 is associated with an interesting VLR 58, SGSN 62 or MME (indicated by arrow 88) and until either (i) the apparatus 70 receives a location update message that indicates that the mobile device 2 is now associated with an uninteresting VLR 58, SGSN 62 or MME (in which case the state machine returns to the idle state 80 as indicated by arrow 89), or (ii) the apparatus 70 determines from a response to a request message that the mobile device 2 is in a location area or routing area of interest (in which case the state machine moves to the searching state 84 as indicated by arrow 90).

In the searching state 84 the apparatus 70 determines the cell identity or service area for the mobile device 2 by sending request messages (e.g. ATI messages) to the visited network 14 (corresponding to step 1119 of FIG. 5). These request messages can be sent periodically with a relatively short time interval between requests (compared to the time interval used in the scanning state 82). For example the time interval can be of the order of the length of the HPPLMN timer (although it does not have to match the current HPPLMN timer value), so for example the time interval can be up to 30 minutes.

The state machine remains in the searching state 84 while location update messages are received that indicate that the mobile device 2 is associated with an interesting VLR 58, SGSN 62 or MME (indicated by arrow 91) and until either (i) the apparatus 70 receives a location update message that indicates that the mobile device 2 is now associated with an uninteresting VLR 58, SGSN 62 or MME (in which case the state machine returns to the idle state 80 as indicated by arrow 92), (ii) the apparatus 70 determines from a response to a request message that the mobile device 2 is no longer in a location area or routing area of interest (in which case the state machine moves back to the scanning state 82 (indicated by arrow 93), or (iii) the apparatus 70 determines from a response to a request message that the mobile device 2 is in a cell or service area of interest (in which case the state machine moves to the retrieving state 86 as indicated by arrow 94).

In the retrieving state 86 the apparatus 70 sends or causes to send a message to the visited network 14 to change one or more services of the mobile device 2 (as in step 1003 above). The state machine remains in the retrieving state 86 while location update messages are received that indicate that the mobile device 2 is associated with an interesting VLR 58, SGSN 62 or MME (indicated by arrow 95) and until either (i) the apparatus 70 receives a location update message that indicates that the mobile device 2 is now associated with an uninteresting VLR 58, SGSN 62 or MME (in which case the state machine returns to the idle state 80 as indicated by arrow 96), or (ii) the mobile device 2 reattaches or reconnects to the home network 4 (in which case the state machine returns to the idle state 80).

As an alternative to the technique shown in FIGS. 5 and 6, the mobile device 2 can determine if it is in a part of the visited network 14 where there may be coverage from the home network 4, and the mobile device 2 can send a signal indicating that there may be coverage from the home network 4 to the home network 4 (which can be intercepted or read by the apparatus 70). This embodiment makes use of the technique described in GB 2485552 in which the mobile device 2 maintains a list of cells in the visited network 14 where there is or may be coverage from the home network 4 (for example stored in a subscriber identity module (SIM) of the mobile device 2), and the mobile device 2 compares its location information to the stored list of cells. If the mobile device 2 determines that it is in a cell where there may be coverage from the home network 4, the mobile device 2 can send a message to the apparatus 70 indicating this. Thus, in this embodiment step 1001 comprises the apparatus 70 receiving the message from the mobile device 2 indicating that it might have coverage from the home network 4, and then triggering step 1003.

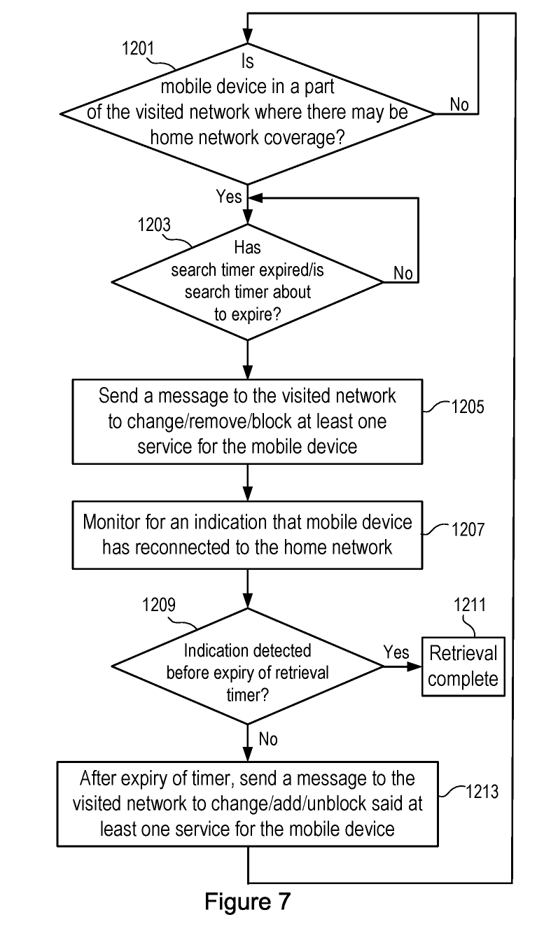

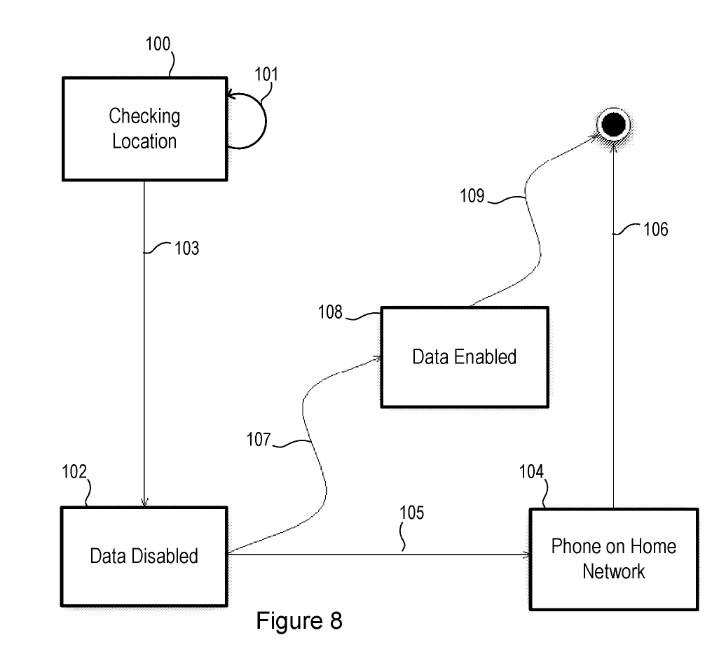

An exemplary method according to an embodiment of the invention is shown in FIG. 7. FIG. 8 shows a state machine illustration of the exemplary method in the specific example where a data service for the mobile device 2 is disabled.

The method starts with step 1201 in which it is determined whether the mobile device 2 is in a part of the visited network 14 where there may be coverage from the home network 4. Step 1201 corresponds to step 1001, and thus can be implemented according to any of the techniques or embodiments described above, including as shown in FIGS. 5 and 6. Step 1201 corresponds to location checking state 100 in FIG. 8. If it is determined that the mobile device 2 is not in the coverage of the home network 4, then step 1201 repeats (indicated by arrow 101 in FIG. 8).

If it is determined that the mobile device 2 is in a location where there may be coverage from the home network 4, then in step 1203 it is determined whether the search timer that regulates the performance of the home network search has expired or is about to expire. As noted above, the home network 4 will be aware of the search timer value set for the mobile device 2, and the home network 4 will also know when the mobile device 2 started roaming, so it is straightforward to determine when the search timer is about to expire of if it has expired. If the search timer is not about to expire (e.g. the remaining timer value is more than a few seconds) or has not expired, then step 1203 repeats after a time delay (e.g. a few seconds). If the search timer is about to expire (e.g. within a few seconds) or has expired (in which case the search timer is latched), the method moves to step 1205 in which the apparatus 70 sends a message to the visited network to change (e.g. remove or block) at least one service for the mobile device 2. Step 1205 corresponds to step 1003, and thus can be implemented according to any of the techniques or embodiments described above.

In the exemplary method shown in FIG. 8, the attempt to retrieve the mobile device 2 involves removing or blocking one or more PDP contexts active for the mobile device 2 in the SGSN 62 or MME of the visited network 14, and specifically a PDP context associated with Internet access. Thus, in FIG. 8, if it is determined that the mobile device 2 is in a location where there may be coverage from the home network 4 (and optionally it has been determined that the search timer has, or will shortly, expire) then the state machine moves into a ‘data disabled’ state 102 (as indicated by arrow 103), in which a MAP deleteSubscriberData message or Diameter Delete Subscriber Data Request message (or a MAP insertSubscriberData message or Diameter Insert Subscriber Data Request message) is sent to the visited network 14. As noted above, the MAP deleteSubscriberData message or Diameter Delete Subscriber Data Request message can indicate the identity of the PDP context or contexts to be removed or blocked or the MAP insertSubscriberData message or Diameter Insert Subscriber Data Request message can indicate the identity of the PDP context or contexts to be maintained (and excluding the PDP context or contexts to be removed or blocked).

The change in the service resulting from step 1205 or state 102 can result in the mobile device 2 becoming idle or entering an idle state, which allows the mobile device 2 to perform the search for the home network 4.

After sending the message in step 1205, the apparatus 70 waits or monitors for an indication that the mobile device 2 has reconnected to the home network 4 (step 1207/state 104). The apparatus 70 can determine that the mobile device 2 has reconnected to the home network 4 in several ways. In a first way, the apparatus 70 monitors location update messages in the home network 4 (e.g. that are sent to the HLR 46 or HSS by other nodes in the home network 4). If the mobile device 2 connects to the home network 4 then the apparatus 70 will observe location update messages (e.g. updateLocation or updateGprsLocation messages or Diameter ‘Update Location Request’ and ‘Update Location Acknowledgement’ messages) that show a location in the home network 4. In a second way, in which the apparatus 70 is able to monitor an interconnect 68 between the home network 4 and the visited network 14 (e.g. network 68), the apparatus 70 can monitor for messages that are exchanged with the visited network's VLR 58, SGSN 62 or MME that result in the deletion of the mobile device's information from the VLR 58, SGSN 62 or MME. In particular, the apparatus 70 can observe a MAP cancelLocation message concerning the mobile device 2 that is sent to the visited network's SGSN 62 or a Diameter Cancel-Location-Request that is sent to the visited network's MME or a Diameter Cancel-Location-Answer that is sent in response to the Diameter Cancel-Location-Request.

If the mobile device 2 is going to return to the home network 4 as a result of the services of the mobile device 2 being changed, it will do so relatively quickly, typically within 30 seconds of going idle. Thus, the apparatus 70 waits for a timeout period (also referred to as a ‘retrieval timer’) from the sending of the message in step 1205 to detect the mobile device 2 returning to the home network 4. The timeout period can be any suitable duration, for example 30 seconds or 1 minute. If the apparatus 70 detects that the mobile device 2 has returned to the home network 4 within the timeout period (step 1209), then the retrieval of the mobile device 2 is complete (step 1211), and the state machine is in state 104 (indicated by arrow 105 from data disabled state 102). The state machine process then ends (arrow 106).

When the mobile device 2 reconnects to the home network 4 as a result of the retrieval process described herein, the home network 4 will restore the changed/blocked/removed service (e.g. Internet access) as part of the normal updateGprsLocation dialogue messages exchanged between the HLR 46 and the home SGSN 42/VLR 38, or as part of the normal Diameter Update Location messages exchanged between the HSS and the MME.

An attempt to retrieve a mobile device 2 can fail for a number of reasons. For example there may not be any coverage from the home network 4 where the mobile device 2 is located. This may occur where the home network coverage information is incorrect or out of date, or where there is only coverage from the home network 4 in part of the cell in which the mobile device 2 is located (and the mobile device 2 is located in the other part). As another example, even with the change to the service caused by the message sent in step 1205, the mobile device 2 may not be in an idle state before the timeout period expires. For example, even if a data service is removed or blocked, voice and messaging services may be maintained, and therefore if the mobile device 2 is active on a voice call for the full duration of the timeout period then the mobile device 2 will be prevented from becoming idle before the timeout period expires.

If, however, the apparatus 70 does not detect that the mobile device 2 has returned to the home network 4 within the timeout period and the mobile device 2 has remained on the visited network 14 then the apparatus 70 sends a message to the visited network 14 to undo the change to the service caused by the message sent in step 1205 (step 1213) (as otherwise the service for the mobile device 2 will remain blocked or removed). Thus, where the message in step 1205 blocked or removed a service, the message in step 1213 can add, unblock, restore or re-establish that service. The expiry of the timeout period is indicated in FIG. 8 by the transition from data disabled state 102 via arrow 107 to data enabled state 108. Where data services are changed as a result of a MAP deleteSubscriberData message MAP insertSubscriberData message in step 1205, step 1213 can comprise sending a (or another) MAP insertSubscriberData message to the SGSN 62 in the visited network 14 that is associated with the mobile device 2. The MAP insertSubscriberData message can include the PDP context information for the data services for the mobile device 2. Where data services are changed as a result of a Diameter Delete Subscriber Data Request message or Diameter Insert Subscriber Data Request message in step 1205, step 1213 can comprise sending a (or another) Diameter Insert Subscriber Data Request message to the MME in the visited network 14 that is associated with the mobile device 2. The Diameter Insert Subscriber Data Request message can include the PDP context information for the data services for the mobile device 2. The PDP context information will have been obtained by the apparatus 70 when monitoring the attachment dialogues (updateLocation and updateGprsLocation messages or Diameter Update Location messages) when the mobile device 2 attached to the visited network 14.

If the mobile device 2 does not reconnect to the home network 4 but connects to a different visited network 14 then the apparatus 70 will detect this from location update messages sent to the home network 4 from the new visited network 14, but it is not necessary for the apparatus 70 to take any action to restore the changed service, since the attachment process to the new visited network 14 will involve establishing all of the required services.

After re-enabling the changed service in step 1213/state 108, the method returns to step 1201, and the state machine process ends (arrow 109).

Therefore there is provided a solution that aims to reconnect or reattach a mobile device 2 to the home network 4 quicker than in conventional techniques.

It will be appreciated that the invention presented in above description is merely exemplary and illustrative, and the invention is not limited to the embodiments described above or shown in the figures. Instead, the scope of the invention is as defined in the attached claims. A computer program, such as that provided to cause an apparatus or network node to operate according to any of the techniques or methods described above, may be stored on any suitable medium (e.g. a non-transitory medium), or in any suitable tangible form, as part of a computer program product. A suitable storage medium can include any type of volatile or non-volatile memory device or module, such as a solid-state storage medium, or an optical storage medium.

1. A method of initiating a search for a home network in a mobile device that is attached to a network other than a home network of the mobile device, the method in an apparatus comprising:
determining whether the mobile device is in a part of said other network where there may be coverage from the home network; and
if the mobile device is determined to be in a part of said other network where there may be coverage from the home network, sending a message to said other network in order to change one or more of a voice, messaging and/or data service available to the mobile device, such that the mobile device can enter an idle state and perform a search for the home network.

2. A method as defined in claim 1, wherein the message sent to said other network is for blocking or removing said voice, messaging and/or data service.

3. A method as defined in claim 1 or 2, wherein the message sent to said other network changes a data service available to the mobile device.

4. A method as defined in claim 3, wherein the data service is a service associated with Internet access.

5. A method as defined in any of claims 1-4, wherein the message is a Mobile Application Part, MAP, deleteSubscriberData message or MAP insertSubscriberData message.

6. A method as defined in claim 5, wherein the message is sent to a visitor location register, VLR, or Serving General Packet Radio Service, GPRS, Support Node, SGSN, in said other network that is associated with the mobile device.

7. A method as defined in any of claims 1-4, wherein the message is a Diameter Delete Subscriber Data Request message or Diameter Insert Subscriber Data Request message.

8. A method as defined in claim 7, wherein the message is sent to a Mobility Management Entity, MME, in said other network that is associated with the mobile device.

9. A method as defined in any of claims 1-8, wherein the step of determining whether the mobile device is in a part of said other network where there may be coverage from the home network comprises:
determining a location of the mobile device in said other network from messages sent from said other network to the home network; and
comparing said determined location to information indicating locations in said other network where there may be coverage from the home network.

10. A method as defined in any of claims 1-9, wherein the step of sending the message to said other network in order to change said voice, messaging and/or data service is only performed if the mobile device is determined to be in a part of said other network where there may be coverage from the home network and a home network search timer for the mobile device has expired or is about to expire.

11. A method as defined in any of claims 1-10, wherein after sending a message to said other network in order to change said voice, messaging and/or data service, the method further comprises the step of:
determining if the mobile device reconnects to the home network.

12. A method as defined in claim 11, wherein the step of determining if the mobile device reconnects to the home network comprises:
monitoring location update messages concerning the mobile device sent to a home location register, HLR, or Home Subscriber Server, HSS, in the home network or sent by a network node in the home network.

13. A method as defined in claim 11, wherein the step of determining if the mobile device reconnects to the home network comprises:
monitoring messages sent from the home network to said other network to remove information about the mobile device from said other network.

14. A method as defined in any of claims 11-13, wherein if it is determined that the mobile device has not reconnected to the home network and stays attached to said other network, the method further comprises the step of:
sending a message to said other network to undo the change to said voice, messaging and/or data service.

15. A method as defined in claim 14, wherein the message to undo the change to said voice, messaging and/or data service is sent on expiry of a retrieval timer that is triggered when the message to change said voice, messaging and/or data service is sent to said other network.

16. A method as defined in claim 14 or 15 wherein the message to undo the change to said voice, messaging and/or data service unblocks or restores said voice, messaging and/or data service.

17. A method as defined in any of claims 14-16, wherein the message to undo the change to said voice, messaging and/or data service is a Mobile Application Part, MAP, insertSubscriberData message, or Diameter Insert Subscriber Data Request message.

18. A computer program product comprising a computer readable medium having computer readable code embodied therein, the computer readable code being configured such that, on execution by a suitable computer or processor, the computer or processor is caused to perform the method of any of claims 1-17.

19. An apparatus for use in initiating a search for a home network in a mobile device that is attached to a network other than a home network of the mobile device, the apparatus being configured to:
determine whether the mobile device is in a part of said other network where there may be coverage from the home network; and
send a message to said other network in order to change one or more of a voice, messaging and/or data service available to the mobile device, such that the mobile device can enter an idle state and perform a search for the home network if the mobile device is determined to be in a part of said other network where there may be coverage from the home network.

20. An apparatus as defined in claim 19, wherein the message sent to said other network is for blocking or removing said voice, messaging and/or data service.

21. An apparatus as defined in claim 19 or 20, wherein the message sent to said other network changes a data service available to the mobile device.

22. An apparatus as defined in claim 21, wherein the data service is a service associated with Internet access.

23. An apparatus as defined in any of claims 19-22, wherein the message is a Mobile Application Part, MAP, deleteSubscriberData message or MAP insertSubscriberData message.

24. An apparatus as defined in claim 23, wherein the message is sent to a visitor location register, VLR, or Serving General Packet Radio Service, GPRS, Support Node, SGSN, in said other network that is associated with the mobile device.

25. An apparatus as defined in any of claims 19-22, wherein the message is a Diameter Delete Subscriber Data Request message or a Diameter Insert Subscriber Data Request message.

26. An apparatus as defined in claim 25, wherein the message is sent to a Mobility Management Entity, MME, in said other network that is associated with the mobile device.

27. An apparatus as defined in any of claims 19-26, wherein the apparatus is configured to determine whether the mobile device is in a part of said other network where there may be coverage from the home network by:
determining a location of the mobile device in said other network from messages sent from said other network to the home network; and
comparing said determined location to information indicating locations in said other network where there may be coverage from the home network.

28. An apparatus as defined in any of claims 19-27, wherein the apparatus is configured to send the message to said other network in order to change said voice, messaging and/or data service only if the mobile device is determined to be in a part of said other network where there may be coverage from the home network and a home network search timer for the mobile device has expired or is about to expire.

29. An apparatus as defined in any of claims 19-28, wherein apparatus is configured to determine if the mobile device reconnects to the home network after sending the message to said other network in order to change said voice, messaging and/or data service.

30. An apparatus as defined in claim 29, wherein the apparatus is configured to determine if the mobile device reconnects to the home network by:
monitoring location update messages concerning the mobile device sent to a home location register, HLR, or Home Subscriber Server, HSS, in the home network or sent by a network node in the home network.

31. An apparatus as defined in claim 29, wherein the apparatus is configured to determine if the mobile device reconnects to the home network by:
monitoring messages sent from the home network to said other network to remove information about the mobile device from said other network.

32. An apparatus as defined in any of claims 29-31, wherein the apparatus is configured to send a message to said other network to undo the change to said voice, messaging and/or data service if it is determined that the mobile device has not reconnected to the home network and stayed attached to said other network.

33. An apparatus as defined in claim 32, wherein the apparatus is configured to send the message to undo the change to said voice, messaging and/or data service on expiry of a retrieval timer that is triggered when the message to change said voice, messaging and/or data service is sent to said other network.

34. An apparatus as defined in claim 32 or 33, wherein the message to undo the change to said voice, messaging and/or data service is configured to unblock or restore said voice, messaging and/or data service.

35. An apparatus as defined in any of claims 32-34, wherein the message to undo the change to said voice, messaging and/or data service is a Mobile Application Part, MAP, insertSubscriberData message, or Diameter Insert Subscriber Data Request message.

36. An apparatus as defined in any of claims 19-35, wherein the apparatus comprises processing circuitry that is configured to determine whether the mobile device is in the part of said other network where there may be coverage from the home network, and interface circuitry that is configured to send the message to said other network in order to change one or more of a voice, messaging and/or data service available to the mobile device.

37. A method, comprising:
in an apparatus, initiating a search for a home network in a mobile device that is attached to a network other than a home network of the mobile device as claimed in any of claims 1-17; and
in said network other than the home network of the mobile device, receiving the message from the apparatus; and changing the one or more of a voice, messaging and/or data service available to the mobile device.

38. A method as defined in claim 37, the method further comprising:
the mobile device entering an idle state in response to the one or more of the voice, messaging and/or data service available to the mobile device being changed;
and initiating a search for a home network.

39. A system, comprising:
an apparatus as claimed in any of claims 19-38; and
a node in said network other than the home network of the mobile device, said node being configured to receive the message from the apparatus; and change the one or more of a voice, messaging and/or data service available to the mobile device.

40. A system as defined in claim 39, the system further comprising:
a mobile device that is configured to enter an idle state in response to the one or more of the voice, messaging and/or data service available to the mobile device being changed; and initiate a search for a home network.

41. An apparatus substantially as described herein, with reference to, and as shown in, FIG. 4 of the accompanying drawings.

42. A method of initiating a search for a home network in a mobile device that is attached to a network other than a home network of the mobile device substantially as described herein, with reference to, and as shown in, any of FIGS. 3 and 5-9.
